(19) United States
(12) Patent Application Publication
(10) Pub. No.: US 2025/0095074 A1
(43) Pub. Date: Mar. 20, 2025

(54) SYSTEMS AND METHODS FOR IDENTIFYING GAPS IN INSURANCE COVERAGE

(71) Applicant: Wells Fargo Bank, N.A., San Francisco, CA (US)

(72) Inventors: Rameshchandra Bhaskar Ketharaju, Hyderabad (IN); Sreenivasa Garlapati, Hyderabad (IN); Venkata P. Sura, Hyderabad (IN)

(21) Appl. No.: 18/469,296

(22) Filed: Sep. 18, 2023

(51) Int. Cl. G06Q 40/08; G06F 16/23

(52) U.S. Cl. CPC G06Q 40/08; G06F 16/2358; G06F 16/2379; G06Q 2220/00

(57) ABSTRACT

Systems, apparatuses, methods, and computer program products are disclosed for identifying gaps in insurance coverage. An example method includes receiving, by communications hardware, an indication of a parcel and a set of property configuration parameters regarding the parcel and retrieving, by a data fabric engine and via a blockchain network, a set of compliance requirements for the set of property configuration parameters. The example method further includes generating, by the data fabric engine and based on the set of compliance requirements, a parcel profile and causing, by an advisory circuitry and based on the parcel profile, presentation of a compliance graphic illustrating the parcel and one or more data layers.

### BACKGROUND

Lenders typically require proof of property insurance before they will finance a loan. Thus, borrowers may obtain property insurance prior to meeting with a lender. Even after securing a loan, homeowners may change insurance providers multiple times throughout the life of the loan. It is not uncommon, therefore, for borrowers to obtain insurance coverage that does not comply with lender requirements or that will be insufficient to cover risks associated with the property.

### BRIEF SUMMARY

As mentioned above, property insurance is generally required by lenders who finance loans on property. Compliant property insurance provides protection to both the borrower and the lender from financial and/or legal burdens. For example, assume an individual owns a property with a mortgage from a financial institution (e.g., bank) and the individual decides to change his flood insurance coverage. The financial institution may identify at some point that the insurance policy is not in compliance with its requirements, but the process of revisiting or revising insurance arrangements can leave a gap in coverage during the time necessary to secure suitable insurance. This delay exposes both the borrower and lender to a risk of loss until the borrower obtains the sufficient insurance coverage. If a flood severely damages or destroys the property before the borrower obtains compliant flood insurance, the borrower may become financially overwhelmed with the repair costs and default on the loan. As a result, the lender may struggle to recover its losses if the flood damage significantly decreases the property's value. In this regard, it is in the best interest of both the borrower and the lender to avoid gaps in insurance coverage.

An entity that provides loans (e.g., lenders) to borrowers may reference data (e.g., third party data or internal data) to determine whether a property insurance policy is compliant with its requirements. For example, lenders may use a third-party to determine the compliance of insurance policies. However, lenders may be required to share personal identifiable information (e.g., unique user information, address information, or the like) with the third-party. In another example, a lender may reference a variety of different types of data, such as flood zone maps, geological surveys, appraisal or inspection reports, government requirements, the type of loan, a borrower's credit worthiness, and/or the like. However, due to inadequate awareness of insurance requirements by either the borrower or the lender, unavailability of relevant information, and/or ineffective communication between the borrower and the lender, the borrower may nevertheless obtain non-compliant insurance coverage that fails to meet the lender's requirements. In addition, insurance policies and requirements may change over time. For example, assume a flood map indicates that a property is outside a flood zone. The borrower may initially have compliant insurance policies despite the borrower not obtaining flood insurance. However, a government agency (e.g., FEMA) may release a new flood map that places the property within a flood zone. Consequentially, the new flood zone indicates that both the borrower and the lender may be at risk given the newly raised likelihood that there is potential for flood damage to the property.

Example embodiments alleviate the issues discussed above by providing a real-time graphical engine and architecture that leverages data from a variety of sources (e.g., government entities, financial institutions, or the like), utilizes a plurality of nodes included in a blockchain network to verify real-time updates to insurance requirements, and leverages smart contracts to automate retrieval of current insurance requirements to determine in current insurance requirements for a particular parcel (e.g., a property), ascertain if a particular insurance policy meets the determined insurance requirements, and cause presentation of a graphical depiction of the property that includes visual indicators (e.g., one or more data layers) corresponding to a status of each insurance policy and/or insurance requirements.

Example embodiments may receive an indication of a parcel and a set of property configuration parameters regarding a parcel. In some embodiments, an indication of a parcel may be data that points to a particular parcel, such as the location of the parcel (e.g., an address, coordinates, or the like). In some embodiments, the set of property configuration parameters regarding the parcel may be data that describes several variables about the parcel that may be used to identify gaps in insurance coverage, such as a property valuation, an existing insurance plan, a particular lender, a particular borrower, and/or the like.

Example embodiments may also retrieve a set of compliance requirements via a blockchain network for the set of property configuration parameters. In some embodiments, the set of compliance requirements may describe a set of rules/requirements used to determine if a borrower's insurance policies are compliant based one requirements outlined by a governing agency, media, private agencies, and/or the like. For example, a set of rules associated with a government produced flood map and derived by a node in a blockchain network may describe flood insurance requirements for a particular location. In some embodiments, the blockchain network may comprise of a plurality of smart contracts that may be leveraged to retrieve data from the blockchain network without exposing personal identifiable information. In some embodiments, the blockchain network may comprise of a plurality of nodes such that if a node transmits an update notification that indicates an update to the set of compliance requirements, the update is verified by the plurality of nodes.

Example embodiments may also generate a parcel profile based on the set of compliance requirements. In some embodiments, the parcel profile may comprise data that describes a set of compliance values associated with the set of property configuration parameters. For example, the set of compliance values may be a set of numerical scores that are based on the compliance of a property configuration parameters with the set of compliance requirements. Example embodiments may also cause presentation of a compliance graphic illustrating the parcel and one or more data layers based on the parcel profile. In some embodiments, the compliance graphic illustrates the parcel by displaying one or more data layers associated with the set of compliance values, such that the one or more data layers overlay the parcel. In addition, a transparency value may be associated with each compliance value such that each of the one or more data layers transparency is based on the satisfaction of a particular compliance requirements. For example, if a compliance value indicates satisfaction of a compliance requirement, the data layer may be transparent. Alternatively, the compliance value may not satisfy a compliance requirement. For example, the one or more data layers associated with a compliance value that does not satisfy a compliance requirement may not be transparent and therefore may provide a visual indicator (e.g., a particular color, texture, pattern, and/or the like) that represents the non-compliant requirement on the compliance graphic.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2 illustrates a schematic block diagram of example circuitry embodying a system device that may perform various operations in accordance with some example embodiments described herein.

FIG. 3 illustrates an example flowchart for identifying gaps in insurance coverage, in accordance with some example embodiments described herein.

FIG. 4 illustrates an example flowchart for updating a compliance graphic based on receiving an update from a blockchain network, in accordance with some example embodiments described herein.

FIG. 5 illustrates a swim lane diagram with example operations that may be performed by components of the environment depicted in FIG. 1, in accordance with some example embodiments described herein.

FIG. 6 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

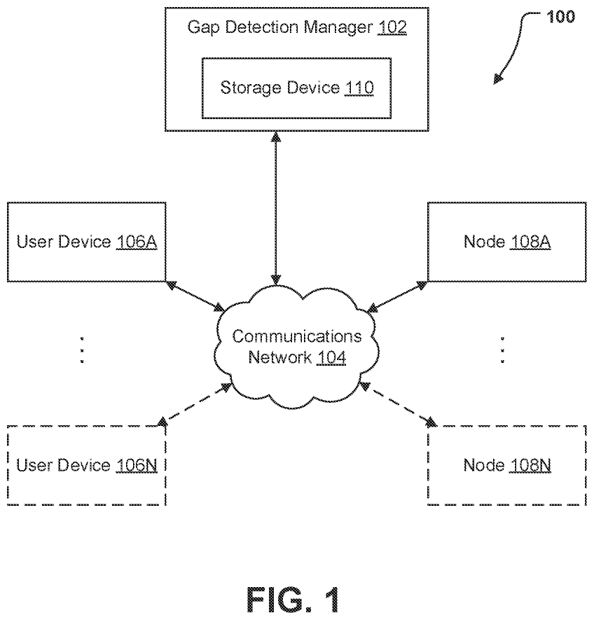

Example embodiments described herein may be implemented using any of a variety of computing devices or servers. To this end, FIG. 1 illustrates an example environment 100 within which various embodiments may operate. As illustrated, a gap detection manager 102 may receive and/or transmit information via communications network 104 (e.g., the Internet) with any number of other devices, such as one or more of user devices 106A-106N and/or nodes 108A-108N. For example, the one or more nodes 108A-108N may be included in a blockchain network that verifies updates to compliance requirements. In addition, the one or more user devices 106A-106N may be associated with an individual (e.g., a user), financial institution, mortgage servicer, mortgage lender, or government agencies such as The Federal Emergency Management Agency (FEMA), The US Department of Agriculture Forest Service, The United States Geological Survey (USGS), state and local government agencies, and/or the like.

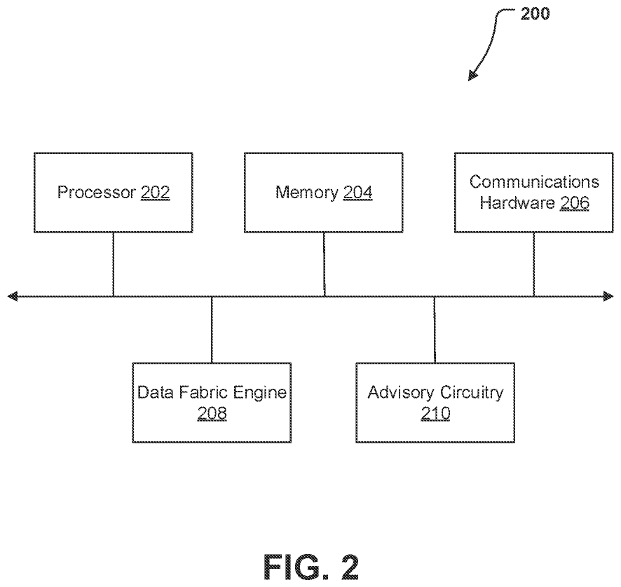

The gap detection manager 102 may be implemented as one or more computing devices or servers, which may be composed of a series of components. Particular components of the gap detection manager 102 are described in greater detail below with reference to apparatus 200 in connection with FIG. 2.

In some embodiments, the gap detection manager 102 further includes a storage device 110 that comprises a distinct component from other components of the gap detection manager 102. Storage device 110 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). Storage device 110 may host the software executed to operate the gap detection manager 102. Storage device 110 may store information relied upon during operation of the gap detection manager 102, such as various algorithms that may be used by the gap detection manager 102, data and documents to be analyzed using the gap detection manager 102, or the like. In addition, storage device 110 may store control signals, device characteristics, and access credentials enabling interaction between the gap detection manager 102 and one or more of the user devices 106A-106N or nodes 108A-108N.

The one or more user devices 106A-106N and the one or more nodes 108A-108N may be embodied by any computing devices known in the art. The one or more user devices 106A-106N and the one or more nodes 108A-108N need not themselves be independent devices, but may be peripheral devices communicatively coupled to other computing devices. In some embodiments, the one or more nodes 108A-108N may be nodes included in a blockchain network. In some embodiments, the one or more nodes 108A-108N may be computing devices associated with a particular entity that determines compliance requirements included in the set of compliance requirements.

### Example Implementing Apparatuses

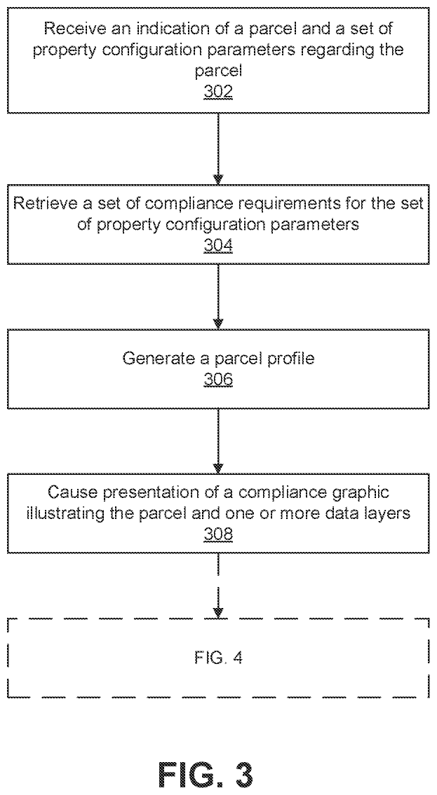

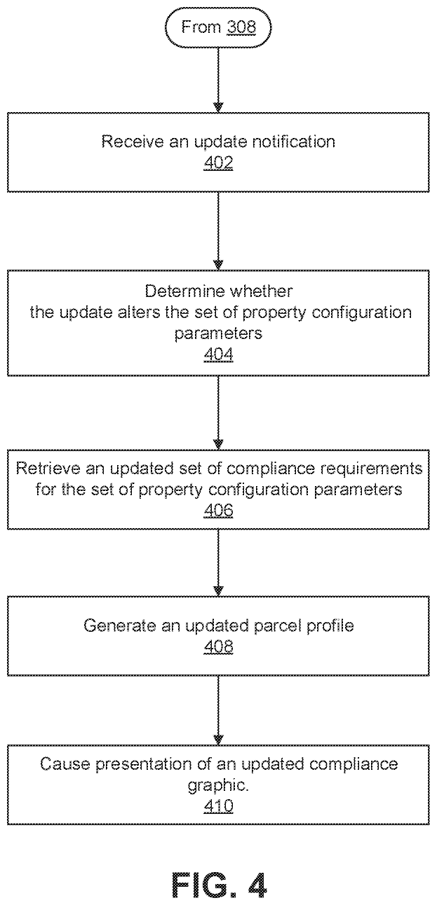

The gap detection manager 102 (described previously with reference to FIG. 1) may be embodied by one or more computing devices or servers, for example the apparatus 200 shown in FIG. 2. The apparatus 200 may be configured to execute various operations described above in connection with FIG. 1 and below in connection with FIGS. 3-4. As illustrated in FIG. 2, the apparatus 200 may include processor 202, memory 204, communications hardware 206, data fabric engine 208 and advisory circuitry 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a data fabric engine 208 that is configured to retrieve a set of compliance requirements for the set of property configuration parameters. The data fabric engine 208 may also be configured to generate a parcel profile based on the set of compliance requirements. The data fabric engine 208 may utilize processor 202, memory 204, or any other hardware component included in the apparatus 200 to perform these operations, as described in connection with FIGS. 3-4 below. The data fabric engine 208 may further utilize communications hardware 206 to gather data from a variety of sources (e.g., user device 106A through user device 106N or a blockchain network that may comprise node 108A through node 108N, as shown in FIG. 1), and/or exchange data with a user, and in some embodiments may utilize processor 202 and/or memory 204 to perform any or more of the above operations.

Further, the apparatus 200 further comprises an advisory circuitry 210 that is configured to cause presentation of a compliance graphic illustrating the parcel and one or more data layers. The advisory circuitry 210 may utilize processor 202, memory 204, or any other hardware component included in the apparatus 200 to perform these operations, as described in connection with FIGS. 3-4 below. The advisory circuitry 210 may further utilize communications hardware 206 to gather data from a variety of sources (e.g., user device 106A-106N or a blockchain network that may comprise nodes 108A-108N, as shown in FIG. 1), and/or exchange data with a computing device associated with a user (e.g., user device 106A) such that the user device 106A presents the exchanged data to the user, and in some embodiments may utilize processor 202 and/or memory 204 to perform any or more of the above operations.

Although components 202-210 are described in part using functional language, it will be understood that the particular implementations necessarily include the use of particular hardware. It should also be understood that certain of these components 202-210 may include similar or common hardware. For example, the data fabric engine 208 and advisory circuitry 210 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the data fabric engine 208 and advisory circuitry 210 may leverage processor 202, memory 204, or communications hardware 206 as described above, it will be understood that any of data fabric engine 208 and advisory circuitry 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that data fabric engine 208 and advisory circuitry 210 may comprise particular machinery designed for performing the functions described herein in connection with such elements of apparatus 200.

In some embodiments, various components of the apparatuses 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3 and 4, example flowcharts are illustrated that contain example operations implemented by example embodiments described herein. The operations illustrated in FIGS. 3 and 4 may, for example, be performed by the gap detection manager 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, data fabric engine 208, advisory circuitry 210, and/or any combination thereof. It will be understood that user interaction with the gap detection manager 102 may occur directly via communications hardware 206, or may instead be facilitated by a separate user device 106A-106N, as shown in FIG. 1, and which may have similar or equivalent physical componentry facilitating such user interaction.

Turning first to FIG. 3, example operations are shown for identifying gaps in insurance coverage.

As shown by operation 302, the apparatus 200 includes means, such as memory 204, communications hardware 206, or the like, for receiving an indication of a parcel and a set of property configuration parameters regarding the parcel. The indication of the parcel comprises data that uniquely identifies a particular parcel, such as the location of the parcel (e.g., an address, coordinates, and/or the like) or unique characteristics of the parcel (parcel dimensions, geographic landmarks contained on the parcel, or the like). In some examples, the indication of the parcel may comprise a serial number identifier for a parcel on the market, such as a serial number assigned to identify a property listing on the Multiple Listing Service (MLS) system. In some embodiments, the set of property configuration parameters regarding the parcel is data that describes various variables about the borrower and the parcel that may be used to identify gaps in insurance coverage, such as a property valuation, an existing insurance plan, a particular lender, a particular borrower (e.g., a unique user identifier), and/or the like.

In some embodiments, an entity (e.g., a mortgage servicer, bank, or an individual, such as an insurance agent, borrower, or the like) may transmit the indication of the parcel and the set of property configuration parameters regarding the parcel to the apparatus 200 (e.g., communications hardware 206). For example, a computing device (e.g., user device 106A, user device 106N, and/or the like) associated with an individual who wishes to identify gaps in insurance coverage for a particular parcel may transmit an indication of the parcel and the set of property configuration parameters regarding the parcel to the apparatus 200 (e.g., communications hardware 206) via a network (e.g., communications network 104, shown in FIG. 1). The communications hardware 206 may receive and store the indication of the parcel and the set of property configuration parameters regarding the parcel in a local storage device (e.g., memory 204, storage device 110, or the like).

In some embodiments, the indication of the parcel and the set of property configuration parameters regarding the parcel may be received from a computing device (e.g., user device 106A, user device 106N, or the like) in response to activation of an automatic trigger event. An automatic trigger event may include a temporal trigger event, a circumstantial trigger event, and/or the like. In some embodiments, the apparatus 200 may monitor for a temporal trigger event that may take place based on rules and/or configurations that cause the indication of a parcel and the set of property configuration parameters regarding the parcel to be transmitted from a computing device (e.g., user device 106A, user device 106N, or the like) within a particular time period or at a particular point in time. For example, an individual my configure the apparatus 200 to instruct user device 106A to periodically (e.g., monthly) transmit an indication of a parcel and a set of property configuration parameters regarding the parcel such that the apparatus 200 periodically identifies gaps in insurance coverage for a particular parcel.

Additionally or alternatively, the apparatus 200 may also monitor for a circumstantial trigger event that may take place based on rules and/or configurations (e.g., predetermined rules defined by a user) that cause an indication of a parcel and the set of property configuration parameters regarding the parcel to be transmitted from a computing device (e.g., user device 106A, user device 106N, or the like) in response to a set of conditions and/or criteria being met. For example, assume that the apparatus 200 configures a computing device associated with FEMA to transmit a notification (e.g., a message) that indicates a new flood map or modification to a flood map occurred whenever an update to a flood map is released. As a result, if a new flood map is released by FEMA, the apparatus 200 may receive the notification from a computing device associated with FEMA and subsequently instruct a particular computing device (e.g., user device 106A) to transmit an indication of a parcel and the set of property configuration parameters regarding the parcel to the apparatus 200 (e.g., communications hardware 206) via a network (e.g., communications network 104, shown in FIG. 1). Circumstantial trigger events are described in further detail below in relation to at least FIG. 4.

As shown by operation 304, the apparatus 200 includes means, such as memory 204, communications hardware 206, data fabric engine 208, or the like, for retrieving a set of compliance requirements for the set of property configuration parameters. In some embodiments, the apparatus 200 may store in a local storage device (e.g., memory 204, or the like) a data set that comprises information that describes one or more particular conditions (e.g., a set of property configuration parameters) and the corresponding entity or entities associated with determining the compliance requirements associated with the one or more particular conditions. For example, the data set may include information that describes particular requirements outlined by particular financial institutions, such as a financial institution requiring particular insurance policies, or the like. As a result, the apparatus 200 (e.g., data fabric engine 208) may search the data set for a particular property configuration parameters to identify and retrieve the set of compliance requirements corresponding the set of property configuration parameters. In some embodiments, the set of compliance requirements may describe a set of rules used to determine if particular insurance policies are compliant for various requirements outlined by a variety of entities (e.g., FEMA, a financial institution, or the like). For example, a subset of compliance requirements included in the set of compliance requirements may be based on a flood map produced by FEMA. The flood map may be used to determine the compliance of particular flood insurance policies (described in further detail below in relation to operation 306).

In some embodiments, data fabric engine 208 may retrieve the indication of the parcel and the set of property configuration parameters regarding the parcel from a local storage device (e.g., memory 204, storage device 110, or the like), and may identify the set of compliance requirements for the set of property configuration parameters. Subsequently, data fabric engine 208 may use techniques such as optical character recognition (OCR), natural language processing (NLP), searching algorithms, and/or the like to identify data included in the set of property configuration parameters that are associated with compliance requirements included in the set of compliance requirements. For example, data fabric engine 208 may OCR any data in the set of property configuration parameters, if needed, and then search for an indicator of a compliance requirement. For example, assume in the above example that data fabric engine 208 identifies from the received indication of the parcel that the parcel is located at a first particular location. Subsequently, data fabric engine 208 may retrieve the compliance requirements associated with the first particular location to identify that the parcel is located outside a flood zone but within a frequent earthquake zone. In addition, assume that data fabric engine 208 used the techniques mentioned above (e.g., OCR, NLP, or the like) to determine that the set of property configuration parameters describe a particular lender (e.g., mortgage servicer) that strictly adheres to FEMA regulations. In this regard, data fabric engine 208 may determine that a compliance requirement request must be generated to retrieve an earthquake hazard map from a node (e.g., node 108A, or the like) included in the blockchain network.

To generate the compliance requirement request, data fabric engine 208 may structure the request (e.g., format the request) such that the compliance requirement request complies with the blockchain networks query language and/or API. For example, the compliance requirement request may describe the type of data being requested, the scope of the query, filtering criteria, and/or the like. If necessary, the compliance requirement request may further include any access authorization information, such as a cryptographic key, digital signature, or the like. Further, the compliance requirement request may include particular parameters derived from or from the indication of a parcel or the set of property configuration parameters, such that the particular data is retrieved from the blockchain network. For example, if a flood map is determined to be relevant for a particular parcel, the address of the particular parcel may be included in the compliance requirement request such that a flood map that includes the particular parcel is retrieved from the blockchain network.

In some embodiments, the blockchain network may host a number of smart contracts that allow the retrieval of data (e.g., compliance requirements) from the blockchain network without exposing personal identifiable information (e.g., user identifiers, address of a parcel/property, or the like). For example, the blockchain network may comprise of a plurality of smart contracts that are each configured to handle requests for respective compliance requirements included in the set of compliance requirements. In some embodiments, the compliance requirement request may invoke a respective smart contract to retrieve corresponding data. For example, assume to invoke a particular function, the compliance requirement request comprises a “get compliance requirements function call” and an address associated with the parcel (e.g., a property address). The smart contract may then automatically execute the get compliance requirements function that retrieves the compliance requirements associated with the address of the parcel. In some embodiments, if needed, the smart contract may verify the authenticity of the request (e.g., verifying a cryptographic key, digital signature, and/or the like) prior to calling the invoked function. In response to successful verification, the requested data may be retrieved and structured into a response that is received by the apparatus 200 (e.g., communications hardware 206).

In some embodiments, following the generation of the compliance requirement request, data fabric engine 208 may leverage communications hardware 206 to transmit the compliance requirement request to one or more nodes included in the blockchain network (e.g., node 108A, node 108N, or the like). For example, data fabric engine 208 may leverage communications hardware 206 to transmit the compliance requirement request to a node in the blockchain network via a network (e.g., communications network 104, shown in FIG. 1). Additionally or alternatively, communications hardware 206 may use a direct API call or an intermediary service that interacts on its behalf to transmit the compliance requirement request to the blockchain network.

Following the blockchain network's and/or smart contract's verification of the compliance requirement request, communications hardware 206 may receive the set of compliance requirements described in the compliance requirement requests. For example, assume the compliance requirement request describes the retrieval of a flood map, earthquake hazards map, and a particular financial institutions lender requirements. In this regard, communications hardware 206 may retrieve from a node included in the blockchain network (e.g., node 108A) a flood map and earthquake hazard map for the parcel and a set of lender requirements associated with a particular financial institution. In some embodiments, following the retrieving of the set of compliance requirements, data fabric engine 208 may store the set of compliance requirements in a local storage device (e.g., memory 204, storage device 110, or the like).

As shown by operation 306, the apparatus 200 includes means, such as memory 204, data fabric engine 208, or the like, for generating a parcel profile. The parcel profile may comprise data that describes a set of compliance values associated with the set of property configuration parameters satisfaction of the set of retrieved compliance requirements. For example, the parcel profile may comprise of a compliance values associated with the particular property configuration parameters included in the set of property configuration parameters compliance of particular compliance requirements included in the set of compliance requirements, such as the location of the parcel/an existing flood insurance policy and a flood map, borrower information and credit worthiness, and/or the like.

In some embodiments, the set of compliance values may include a plurality of compliance values, such that each compliance value included in the set of compliance values is associated with a particular compliance requirement. In some embodiments, the compliance values may indicate the set of property configuration parameters satisfaction of the set of compliance requirements. Said another way, each compliance value indicates the satisfaction of a property configuration parameter, which is included in the set of property configuration parameters, satisfaction of a compliance requirement, which is included in the set of compliance requirements.

In some embodiments, the compliance values may be a computed score that indicates a particular property configuration parameter's satisfaction of a particular compliance requirement. For example, data fabric engine 208 may leverage a compliance value scoring model that assigns a compliance value for each property configuration parameter-compliance requirement pair. For instance, a compliance value may be computed for an existing flood insurance policy selected by an individual satisfaction of a compliance requirement that is based on a flood map describing the flood insurance required for the parcel, or the like. Additionally or alternatively, the compliance value may be converted into a categorical result (e.g., satisfied, somewhat satisfied, not satisfied, a numbered classification such as tier 1, tier 2, or tier 3, a color-coded classification such as green, yellow, or red, and/or the like).

Finally, as shown by operation 308, the apparatus 200 includes means, such as memory 204, communications hardware 206, advisory circuitry 210, or the like, for causing presentation of a compliance graphic illustrating the parcel and one or more data layers. In some embodiments, advisory circuitry 210 may cause presentation of the compliance graphic to a user by transmitting data to a computing device associated with the user such that the transmitted data is presented to the user via the computing device. In some embodiments, advisory circuitry 210 may retrieve the parcel's parameters (e.g., location, size, and/or the like) from the received indication of the parcel and set of property configuration parameters and utilize any technique, such as optical character recognition (OCR), natural language processing (NLP), searching algorithms, and/or the like to identify the entity associated with the indication of the parcel and set of property configuration parameters. For example, advisory circuitry 210 may OCR any data in the set of property configuration parameters and/or the indication of the parcel, if needed, and then search for an indicator of a particular entity, such as a unique user identifier, a MAC address or serial number associated with the computing device that transmitted the indication of the parcel and set of property configuration parameters, and/or the like. Subsequently, advisory circuitry 210 may generate a compliance graphic based on the parcel profile generated in operation 306.

In some embodiments, the compliance graphic may depict one or more data layers. The one or more data layers may display a visual indicator that represents a particular compliance value's status/satisfaction of a particular compliance requirement. In some embodiments, advisory circuitry 210 may retrieve the generated parcel profile (e.g., described in operation 306) from a local storage device (e.g., memory 204, storage device 110, or the like). Advisory circuitry 210 may search the parcel profile for the set of compliance values. For example, assume a parcel profile indicates that a particular individual has non-compliant flood insurance coverage, compliant earthquake coverage, and non-compliant mortgage insurance for a particular parcel. A data layer associated with the non-compliant flood insurance may be illustrated to be overlaying a visual depiction of the parcel on the compliance graphic. In some embodiments, advisory circuitry 210 may generate a visual depiction of the parcel based on the received indication of the parcel in operation 302.

In some embodiments, each of the one or more data layers may have a transparency value that defines each data layer's transparency. For example, the transparency value may be a numerical value that describes the transparency of a data layer depicted in the compliance graphic. For example, transparency values may be from 0 to 1 where 0 is not transparent and 1 is transparent. In some embodiments, the transparency value for a particular data layer may be determined based on the compliance value associated with the particular data layer. In this regard, data layers with compliance values indicating a satisfied compliance requirement may be illustrated as transparent on the compliance graphic. Alternatively, data layers with compliance values that indicate a compliance requirement is not satisfied may not be transparent. For example, assume a data layer is associated with the compliance of title insurance. Advisory circuitry 210 may search the parcel profile for the compliance value associated with title insurance. Subsequently, advisory circuitry 210 may refer to a database or reference table in a local storage device (e.g., memory 204, storage device 110, or the like) that describes the transparency value associated with a particular compliance value. For example, a database storing the transparency values may store compliance values and transparency values in the form of key-value pairs where the key portion specifies the compliance value, and the value portion specifies the transparency value associated with the compliance value. Thus, advisory circuitry 210 may search for a particular compliance value, which may be a key that is associated with a particular transparency value. Continuing the above example, advisory circuitry 210 may search the parcel profile for the compliance value associated with title insurance. The title insurance compliance value may be a categorical result that indicates a somewhat satisfied compliance requirement. Thus, advisory circuitry 210 may search storage device 110 for a reference table that describes that the somewhat satisfied compliance requirement is associated with a 0.5 transparency value.

In some embodiments, the one or more data layers may be associated with a particular format. For example, a format associated with a data layer may describe the visual depiction of the data layer, such as the color, pattern, texture, and/or the like. In some embodiments, one or more data layers may be illustrated using the same format. For example, one or more data layers may be illustrated using a particular color, where the color of a data layer is based on the particular compliance requirement associated with the data layer. Additionally or alternatively, the one or more data layers may comprise of a plurality of formats. For example, a first data layer may be a first color and a first texture, a second data layer may be a second color and a second texture, a third data layer may be a third color and a third texture, and/or the like.

In some embodiments, advisory circuitry 210 may determine a format for each data layer. In some embodiments, advisory circuitry 210 may determine the format for each data layer based on user preference, the amount of data layers included in the compliance graphic, and/or the like. For example, communications hardware 206 may receive a format request from a computing device (e.g., user device 106A, or the like) associated with the entity that transmitted the received indication of the parcel and set of property configuration parameters. The format request may describe the desired format to illustrate the data layers on the compliance graphic.

In some embodiments, advisory circuitry 210 may apply a model to the one or more data layers to determine the format for each data layer. For instance, the model may be configured to prohibit duplication of data layer formatting (e.g., two or more data layers with duplicate colors, formats, textures, and/or the like, such that the two or more data layers are identical). In some embodiments, the model may use a uniqueness constraint to prohibit the duplication of data layers. For example, the model may be consecutively input the one or more data layers. The model may maintain a record of the formats associated with the inputted one or more data layers and if a data layers format matches a previously input data layers format, the model may detect a conflict (e.g., two duplicate data layers). Subsequently, the model may alter the format of one of the two conflicting data layers to resolve the conflict by prohibiting the duplication of data layer formatting.

In some embodiments, the combination of one or more data layers may create a composite format illustrated on the compliance graphic that indicates an overall compliance status for the plurality of data layers. For example, a plurality of data layers, such as a blue data layer and a red data layer may be illustrated on a compliance graphic. The combination of the blue data layer and the red data layer may create a composite data layer that is illustrated as purple. In another example, a plurality of data layers may each possess a different texture such that the created composite data layer is illustrated as a mixture of the plurality of different textures and therefor indicating an overall compliance status. In some embodiments, advisory circuitry 210 may apply a model to create the composite format. For example, advisory circuitry 210 may input the one or more compliance values, the formats for each data layer, transparency values, or the like, and output an indication of the composite format.

In some embodiments, after causing the presentation of the compliance graphic to an entity (e.g., an individual, financial institution, and/or the like), communications hardware 206 may receive a data layer request from the entity. For example, communications hardware 206 may receive a data layer request from a computing device associated with the entity (e.g., user device 106A, or the like) via a network (e.g., communications network 104, shown in FIG. 1). In some embodiments, the data layer request may request additional data (e.g., information) about how to alleviate non-compliant insurance coverage associated with a specific data layer and/or request the status of a specific data layer. For example, a compliance graphic may reveal that an individual has non-compliant title insurance. The data layer request may describe a request for data describing how to transition to a compliant title insurance policy, such as by requesting compliant insurance policies. In response, communications hardware 206 may cause display of information about a compliance status of the specific data layer. In addition, communications hardware 206 may display the mandated insurance requirements, point of contacts, or the like associated with a specific data layer.

In some embodiments, the apparatus 200 may receive updated notification informing the apparatus 200 of updated compliance requirements and/or an updated set of compliance requirements from the blockchain network. Turning now to FIG. 4, example operations are shown for updating a compliance graphic based on receiving an update from the blockchain network.

As shown by operation 402, the apparatus 200 includes means, such as memory 204, communications hardware 206, or the like, for receiving an update notification. In some embodiments the update notification may describe an update to the set of compliance requirements. For example, the update notification may describe that an update to the flood map for a particular area has been released by FEMA, which may impact previously considered compliant flood insurance policies for a parcel located in the flood map.

In some embodiments, communications hardware 206 may receive the update notification from the blockchain network via a network (e.g., communications network 104, shown in FIG. 1). For example, a node included in the plurality nodes in the blockchain network (e.g., node108A, or the like) may transmit the update notification via communications network 104 to the apparatus 200 (e.g., communications hardware 206). Subsequently, communications hardware 206 may store the update notification in a local storage device, such as memory 204, storage device 110, or the like.

In some embodiments, the update notification may be transmitted from the blockchain network (e.g., node 108A) to the apparatus 200 (e.g., communications hardware 206) in response to an automatic trigger event. The automatic trigger event may be a temporal trigger event, a circumstantial trigger event, and/or the like. A temporal trigger event may take place based on rules and/or configurations that cause an update notification to be transmitted from a node in the blockchain network (e.g., node 108A, or the like) to communications hardware 206 within a particular time period or at a particular point in time. For example, the blockchain network may transmit monthly update notifications. In such embodiments, the update notification may describe a plurality of updates that have occurred in the past month. Alternatively, the update notification may describe no updates (e.g., if no updates occurred in the past month the update notification may be empty or indicate that no updates have occurred). In some embodiments, a circumstantial trigger event may take place based on rules and/or configurations that cause the transmission of an update notification from a node included in the blockchain network to communications hardware 206 in response to a set of conditions and/or criteria being met. For example, a node in the blockchain network may be configured to transmit an update notification to communications hardware 206 if there is any update to a FEMA related document (e.g., flood map, earthquake hazards map, and/or the like).

As shown by operation 404, the apparatus 200 includes means, such as memory 204, data fabric engine 208, or the like, for determining whether the update alters the set of property configuration parameters regarding the parcel. In some embodiments, data fabric engine 208 may retrieve the received update notification from a local storage device (e.g., memory 204, storage device 110, or the like). In addition, data fabric engine 208 may use techniques such as optical character recognition (OCR), natural language processing (NLP), searching algorithms, and/or the like to identify the update associated with the update notification. For example, data fabric engine 208 may OCR any data in the update notification, if needed, and then search for an indicator of an update. For instance, data fabric engine 208 may search for the terms “flood map”, “FEMA”, and/or the like, which may be an indicator for an update that may impact the compliance of flood insurance policies, other hazard insurance policies, and/or the like.

In some embodiments, data fabric engine 208 may retrieve the identified update included in the received update notification from a local storage device and use the identified update to search the set of property configuration parameters that may become altered based on the received update notification. For example, assume the update notification describes a new flood map. Data fabric engine 208 may search the set of property configuration parameters associated with the previous flood map, such as previous policies for flood insurance, hazard insurance, the location of the parcel, and/or the like.

In some embodiments, if the set of property configuration parameters are not associated with the update included in the update notification, the procedure may end at operation 404. For example, the update notification may describe a modification and/or update to a flood map for southern Vermont, however, the parcel may not be in the flood zone of the updated flood map (e.g., the parcel is located in Virginia). Alternatively, if the parcel profile includes a set of property configuration parameters that are associated with the update, the apparatus 200 may retrieve data (e.g., an updated set of compliance requirements) from the block chain network, which is described further below in relation to operation 406.

As shown by operation 406, the apparatus 200 includes means, such as memory 204, communications hardware 206, or the like, for retrieving an updated set of compliance requirements for the set of property configuration parameters. In some embodiments, the updated set of compliance requirements may describe modified/new rules used to determine if a borrowers insurance policies are compliant for various requirements outlined by a particular entity (e.g., a government agency such as FEMA, a financial institution, or the like). For example, the updated set of compliance requirements may be based on an updated and/or modified flood map, which may be used to determine the compliance of particular flood insurance policies as described above in relation to operation 306 and below in relation to operation 408. In another example, the updated set of compliance requirements may also be based on an entirely new flood map rather than an updated version of a previous flood map.

In some embodiments, communications hardware 206 may retrieve the updated set of compliance requirements for the set of property configuration parameters regarding the parcel from the blockchain network. For example, communications hardware 206 may transmit an update retrieval request to a node (e.g., node 108A, or the like) in the blockchain network via a network (e.g., communications network 104, shown in FIG. 1). In some embodiments, communications hardware 206 may generate the update retrieval request in a format that complies with the blockchain networks query language (e.g., invoking a function in a smart contract) and/or API. For example, the update retrieval request may describe may describe the type of data requested, such as the scope of the request, filtering criteria, and/or the like. If necessary, the update retrieval request may further include any access authorization information, such as a cryptographic key, digital signature, and/or the like. In addition, the update retrieval request may include particular parameters derived from the update notification (e.g., parameters specifying update data to retrieve where the update data is data that associated with the set of property configuration parameters). Further, the update retrieval request may include an instruction to invoke a function in a smart contract to retrieve data. For example, assume in operation 404 that an update to a flood map in southern Vermont is determined to be associated with the set of property configuration parameters (e.g., the location of the parcel is in southern Vermont). In this regard, the update retrieval request may invoke a function in a smart contract to retrieve the latest flood map for southern Vermont.

In some embodiments, following the transmission of the update retrieval request, communications hardware 206 may receive the requested updated set of compliance requirements for the set of property configuration parameters via a network (e.g., communications network 104, shown in FIG. 1). By continuing the above example, assume the update retrieval request describes an updated flood map in southern Vermont. In this regard, communications hardware 206 may receive from a node included in the blockchain network (e.g., node 108A) an updated flood map for southern Vermont. In some embodiments, following the reception of the updated set of compliance requirements (e.g., an updated flood map for southern Vermont), communications hardware 206 may store updated set of compliance requirements in a local storage device (e.g., memory 204, storage device 110, and/or the like).

As shown by operation 408, the apparatus 200 includes means, such as memory 204, data fabric engine 208, or the like, for generating an updated parcel profile. The updated parcel profile may comprise data that describes a set of updated compliance values for the parcel. In some embodiments, the set of updated compliance values may be a set of computed scores that indicates the set of property configuration parameter's satisfaction of the set of updated compliance requirements. For example, data fabric engine 208 may leverage a compliance value scoring model that computes a numerical score (e.g., a compliance value) for each property configuration parameter and updated compliance requirement pair. For instance, an updated compliance value may be computed for an existing flood insurance policy selected by an individual and an updated flood map that describes the requirements for a compliant flood insurance policy in a particular area. Additionally or alternatively, the updated compliance value may be converted into a categorical result (e.g., satisfied, somewhat satisfied, not satisfied, a numbered classification such as tier 1, tier 2, or tier 3, a color-coded classification such as green, yellow, or red, and/or the like).

In some embodiments, the set of updated compliance values may be associated with the set of property configuration parameters and the updated set of compliance requirements. For example, the updated parcel profile may comprise of an updated compliance value associated with an existing flood insurance (e.g., an existing flood insurance policy described in the set of property configuration parameters) policy's compliance to a new flood map produced by FEMA. Moreover, the updated compliance values associated with the existing flood insurance policy may be based on the retrieved updated set of compliance requirements associated with the new flood map (e.g., operation 406).

In some embodiments, the set of updated compliance values may include one or more updated compliance values for each updated compliance requirement included in the set of updated compliance requirements. In some embodiments, the updated parcel profile may include an updated set of compliance values that replace each of the set of compliance values in the parcel profile. For example, assume that each updated compliance requirement retrieved in operation 406 included in the updated set of compliance requirements includes an update to each compliance requirement in the set of compliance requirements that were retrieved in operation 304. As a result, the set of updated compliance values may differ from the set of compliance values in the parcel profile generated in operation 306 and therefore each compliance value in the updated set of compliance values may modify, replace, and/or alter each of the compliance values included in the set of compliance values.

In some embodiments, the updated parcel profile may include an updated set of compliance values that replace a subset of the set of compliance values. For example, the updated compliance requirements may not include an update to each compliance requirement, the update for a particular compliance requirement may not modify and/or may not alter the compliance values associated with the property configuration parameters and the compliance requirement, and/or the like. For example, although the flood map for a parcel may be updated, the parcel may remain in the same flood zone, despite the updated flood map the parcel's existing flood insurance policy may still be compliant, and/or the like. In another example, the updated set of compliance requirements may be associated with a subset of property configuration parameters and a subset of compliance requirements. Thus, the compliance values associated with the property configuration parameters and compliance requirements that are not included in the subset of property configuration parameters may be included in the updated parcel profile.

Finally, as shown by operation 410, the apparatus 200 includes means, such as memory 204, communications hardware 206, advisory circuitry 210, or the like, for causing presentation of an updated compliance graphic illustrating the parcel and one or more updated data layers. Similar to operation 308, advisory circuitry 210 may cause presentation of the updated compliance graphic to the computing device associated with the entity (e.g., an individual) that transmitted the indication of the parcel and set of property configuration parameters (described in operation 302).

In some embodiments, the updated compliance graphic may illustrate one or more data layers. For example, similar to the procedure followed in operation 308, each illustrated data layer may be associated with a particular format and transparency value. In addition, advisory circuitry 210 may apply a model to determine the particular format for each data layer (e.g., similarly to the model used in operation 308 to prohibit duplicate data layers). In some embodiments, the one or more data layers illustrated on the updated compliance graphic may be identical to its analogous data layer on the compliance graphic presented in operation 308. For example, if a first updated compliance value included in the set of updated compliance values is the same as its analogous particular compliance value included in the set of compliance values then the first data layer, which is based on the first updated compliance value, may be the same as the data layer associated with the particular compliance value (e.g., the data layer in the compliance graphic presented in operation 308).

Additionally or alternatively, the updated compliance graphic may illustrate one or more data layers that are not identical to their analogous data layer on the compliance graphic presented in operation 308. For example, assume a first updated compliance value included in the set of updated compliance values is different than its analogous particular compliance value included in the set of compliance values. In this regard, the first data layer may be different (e.g., the format of the data layer, transparency, and/or the like, may be different indicating a different status for the data layer) than its analogous data layer because each data layer is based on a particular compliance value. Thus, if one or more data layers are not identical to their analogous one or more data layers, composite format presented in operation 308 may indicate a different overall compliance status than the composite format illustrated on the updated compliance graphic (e.g., the composite formats color, texture, pattern, and/or the like, may be different).

FIGS. 3, and 4 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

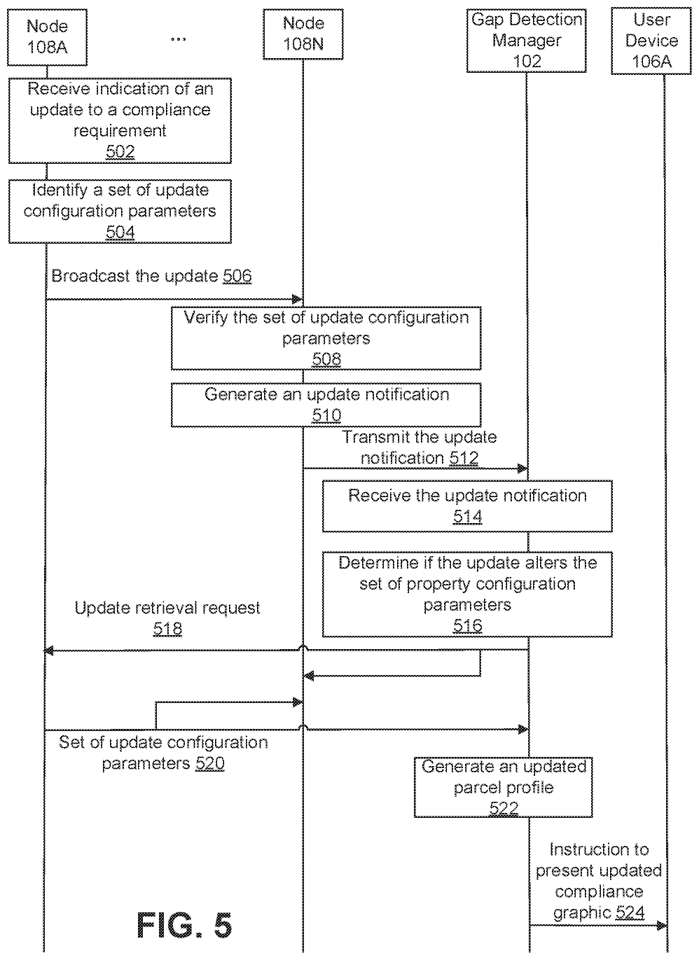

FIG. 5 shows a swim lane diagram illustrating example operations (e.g., as described above in connection with FIGS. 3-4) performed by components of the environment depicted in FIG. 1 to produce various benefits of the implementations described herein. The operations shown in the swim lane diagram performed by node 108A are shown along the line extending from the box labeled “Node 108A”, operations performed by a Node 108N are shown along the line extending from the box labeled “Node 108N”, operations performed by gap detection manager 102 are shown along the line extending from the box labeled “Gap Detection Manager 102”, and operations performed by user device 106A are shown along the line extending from the box labeled “User Device 106A”. Operations impacting multiple devices, such as data transmissions between the devices, are shown using arrows extending between these lines. Generally, these operations are ordered temporally with respect to one another. However, it will be appreciated that the operations may be performed in other orders from those illustrated in FIG. 5.

At operation 502, node 108A may receive indication of an update to a compliance requirement. At operation 504, node 108A may identify a set of update parameters. At operation 506, node 108A may broadcast the update to other nodes, including node 108N. At operation 508, the other nodes, such as node 108N, may verify the set of update parameters. At operation 510, each of these verifying nodes, including node 108N, may generate an update notification based on the verified set of update parameters. At operation 512, node 108N may transmit the update notification to gap detection manager 102. At operation 514, gap detection manager 102 may receive the update notification. At operation 516, gap detection manager 102 may determine if the update alters the set of property configuration parameters. At operation 518, gap detection manager 102 may transmit an update retrieval request to node 108A and/or may broadcast the request, in which case it may also be received by node 108N. At operation 520, node 108A, node 108N, and or any other nodes having received the request may transmit the set of update configuration parameters to gap detection manager 102. At operation 522, gap detection manager 102 may generate an updated parcel profile based on the set of update configuration parameters. At operation 524, gap detection manager 102 may transmit an instruction to present the updated compliance graphic to user device 106A.

In some embodiments, some of the operations described above in connection with FIGS. 3-5 may be modified or further amplified. Furthermore, in some embodiments, additional optional operations may be included. Modifications, amplifications, or additions to the operations above may be performed in any order and in any combination.

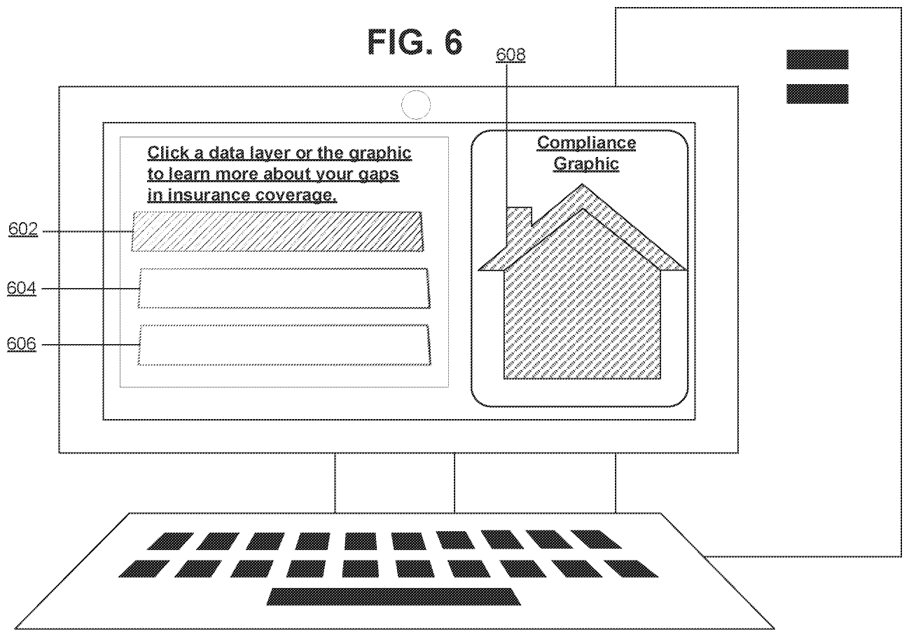

Turning to FIG. 6, a graphical user interface (GUI) is provided that illustrates an example presentation of a compliance graphic on a computing device (e.g., user device 106A, or the like). As noted previously in operation 308 and operation 410, advisory circuitry 210 may cause presentation of a compliance graphic by a computing device associated with an entity (e.g., an individual, insurance agent, mortgage servicer, and/or the like). In such an embodiment, the GUI shown in FIG. 6 may be displayed to the entity by a computing device, such as any of user devices 106A-106N associated with the entity.

Data layer 602, data layer 604, and data layer 606 may be automatically displayed. Alternatively, data layer 602, data layer 604, and data layer 606 may be displayed in response to an entity (e.g., an individual/user) interacting with compliance graphic 608. For example, data layer 602, data layer 604, and data layer 606 may be displayed on the entity's user device in response to a user's interaction (e.g., hovering a cursor over the compliance graphic, clicking the compliance graphic, and/or the like) with the composite pattern on compliance graphic 608. A visual indicator, such as data layer 602 blinking, may prompt a user to click or otherwise interact with data layer 602 to reveal information about the compliance of the insurance policies associated with the data layer (e.g., mandated insurance requirements, point of contacts, and/or the like). The transparency of data layer 604 and data layer 606 may indicate data layers associated with compliant insurance policies. In this regard, data layer 604 and data layer 606 may not blink indicating to the entity that received the compliance graphic that data layer 604 and data layer 606 are associated with compliant insurance policies. In addition, compliance graphic 608 may provide a visual indicator, such as blinking, to prompt a user to interact with the compliance graphic and subsequently view the non-compliant data layer (e.g., data layer 602). Compliance graphic 608 may also illustrates the composite format that depicts the overall status of the plurality of data layers. For example, the overall compliance status for compliance graphic 608 depicts a composite format that matches the pattern illustrated on data layer 602 because data layer 604 and data layer 606 are transparent and thus do not affect the overall compliance status and hence do not affect the composite format.

### CONCLUSION

As described above, example embodiments provide methods and apparatuses that enable improved identification of gaps in insurance coverage by leveraging a block chain network to securely and routinely receive compliance requirement updates that affect the compliance of insurance policies. Example embodiments thus provide tools that overcome the problems faced by entities (e.g., individuals, financial institutions, or the like) that historically lack uniform access to this data. By avoiding the need to manually search for compliance requirements that continuously or spontaneously change over time, example embodiments thus save time and resources, while also eliminating the possibility of human error that has been unavoidable in the past. Moreover, by leveraging a plurality of nodes included in a blockchain network to verify the compliance requirements associated with a new ordinance, flood map, hazard map, or the like embodiments described herein avoid the need for borrowers to inadvertently purchase non-compliant insurance policies based on miscommunications with lender. Finally, automating the retrieval of compliance requirements using smart contracts improves the speed and consistency of the evaluations performed by example embodiments and unlocks many potential new functions that have historically not been available, such as the ability to conduct near-real-time dispute resolution when conclusions drawn regarding records challenges assumptions that have previously been made regarding those records.

As these examples all illustrate, example embodiments contemplated herein thus provide technical solutions that solve real-world problems faced while identifying gaps in insurance coverage. And while detecting gaps in insurance coverage has been an issue for decades, the recently exploding amount of continuously and spontaneously changing compliance requirements has made this problem significantly more acute. Example embodiments described herein thus represent a technical solution to these real-world problems.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for identifying gaps in insurance coverage, the method comprising:
receiving, by communications hardware, an indication of a parcel and a set of property configuration parameters regarding the parcel;
retrieving, by a data fabric engine and via a blockchain network, a set of compliance requirements for the set of property configuration parameters;
generating, by the data fabric engine and based on the set of compliance requirements, a parcel profile, wherein the parcel profile comprises a set of compliance values for the parcel for the set of property configuration parameters; and
causing, by an advisory circuitry and based on the parcel profile, presentation of a compliance graphic illustrating the parcel and one or more data layers, wherein each data layer of the one or more data layers depicts a corresponding compliance value of the set of compliance values.

2. The method of claim 1, further comprising:
receiving, by the communications hardware and via the blockchain network, an update notification, wherein the update notification indicates an update to the set of compliance requirements;
determining, by the data fabric engine, whether the update alters the set of property configuration parameters regarding the parcel; and
in an instance in which the update alters the set of property configuration parameters regarding the parcel:
retrieving, by the communications hardware via the blockchain network, an updated set of compliance requirements for the set of property configuration parameters,
generating, by the data fabric engine and based on the update, an updated parcel profile, wherein the updated parcel profile comprises a set of updated compliance values for the parcel for the set of property configuration parameters, and
causing, by the advisory circuitry and based on the updated parcel profile, presentation of an updated compliance graphic illustrating the parcel and one or more updated data layers, wherein each updated data layer of the one or more updated data layers depict a corresponding updated compliance value for the set of updated compliance values.

3. The method of claim 1, wherein retrieving the set of compliance requirements further comprises:
transmitting, by the communications hardware to the blockchain network, a compliance requirement request, wherein the compliance requirement request invokes a function in a smart contract.

4. The method of claim 1, wherein causing presentation of the compliance graphic comprises:
determining, by the data fabric engine, a transparency value for the one or more data layers, wherein the transparency value for each data layer is based on a compliance value corresponding to that data layer.

5. The method of claim 4, further comprises:
determining, by the advisory circuitry, a format for each data layer.

6. The method of claim 5, wherein determining the format comprises:
applying, by the advisory circuitry, a model to the one or more data layers, wherein the model prohibits duplication of data layer formatting.

7. The method of claim 6, wherein combining formats for a plurality of data layers creates a composite format, wherein the composite format indicates an overall compliance status for the plurality of data layers.

8. The method of claim 1, further comprising:
receiving, by the communications hardware, a data layer request regarding a specific data layer, wherein the data layer request is associated with a user interaction with the compliance graphic; and
causing, by the communications hardware and based on the data layer request, display of information about a compliance status of the specific data layer.

9. An apparatus for identifying gaps in insurance coverage, the apparatus comprising:
communications hardware configured to receive an indication of a parcel and a set of property configuration parameters regarding the parcel;
a data fabric engine configured to:
retrieve a set of compliance requirements for the set of property configuration parameters via a blockchain network; and
generate, based on the set of compliance requirements, a parcel profile, wherein the parcel profile comprises a set of compliance values for the parcel for the set of property configuration parameters; and
an advisory circuitry configured to cause, based on the parcel profile, presentation of a compliance graphic illustrating the parcel and one or more data layers, wherein each data layer of the one or more data layers depicts a corresponding compliance value of the set of compliance values.

10. The apparatus of claim 9, wherein the communications hardware is further configured to receive, via a blockchain network, an update notification, wherein the update notification indicates an update to the set of compliance requirements;
wherein the data fabric engine is further configured to determine whether the update alters the set of property configuration parameters regarding the parcel; and
in an instance in which the update alters the set of property configuration parameters regarding the parcel:
the communications hardware is further configured to retrieve, via the blockchain network, an updated set of compliance requirements for the set of property configuration parameters,
the data fabric engine is further configured to generate, based on the update, an updated parcel profile, wherein the updated parcel profile comprises a set of updated compliance values for the parcel for the set of property configuration parameters, and
the advisory circuitry further configured to cause, based on the updated parcel profile, presentation of an updated compliance graphic illustrating the parcel and one or more updated data layers, wherein each updated data layer of the one or more updated data layers depict a corresponding updated compliance value for the set of updated compliance values.

11. The apparatus of claim 9, wherein the data fabric engine is further configured to determine a transparency value for the one or more data layers, wherein the transparency value for each data layer is based on a compliance value corresponding to that data layer.

12. The apparatus of claim 11, wherein the advisory circuitry is further configured to determine a format for each data layer.

13. The apparatus of claim 12, wherein the advisory circuitry is further configured to apply a model to the one or more data layers, wherein the model prohibits duplication of data layer formatting.

14. The apparatus of claim 9, wherein the communications hardware is further configured to:
receive a data layer request regarding a specific data layer, wherein the data layer request is associated with a user interaction with the compliance graphic; and
cause, based on the data layer request, display of information about a compliance status of the specific data layer.

15. A non-transitory computer-readable storage medium storing instructions that, when executed by an apparatus, cause the apparatus to:
receive an indication of a parcel and a set of property configuration parameters regarding the parcel;
retrieve, via a blockchain network, a set of compliance requirements for the set of property configuration parameters;
generate, based on the set of compliance requirements, a parcel profile, wherein the parcel profile comprises a set of compliance values for the parcel for the set of property configuration parameters; and
cause, based on the parcel profile, presentation of a compliance graphic illustrating the parcel and one or more data layers, wherein each data layer of the one or more data layers depicts a corresponding compliance value of the set of compliance values.

16. The non-transitory computer-readable storage medium of claim 15, wherein the instructions, when executed by the apparatus, further cause the apparatus to:
receive, via the blockchain network, an update notification, wherein the update notification indicates an update to the set of compliance requirements;
determine whether the update alters the set of property configuration parameters regarding the parcel; and
in an instance in which the update alters the set of property configuration parameters regarding the parcel:
retrieve, via the blockchain network, an updated set of compliance requirements for the set of property configuration parameters,
generate, based on the update, an updated parcel profile, wherein the updated parcel profile comprises a set of updated compliance values for the parcel for the set of property configuration parameters, and
cause, based on the updated parcel profile, presentation of an updated compliance graphic illustrating the parcel and one or more updated data layers, wherein each updated data layer of the one or more updated data layers depict a corresponding updated compliance value for the set of updated compliance values.

17. The non-transitory computer-readable storage medium of claim 15, wherein the instructions, when executed by the apparatus, further cause the apparatus to:
determine a transparency value for the one or more data layers, wherein the transparency value for each data layer is based on a compliance value corresponding to that data layer.

18. The non-transitory computer-readable storage medium of claim 17, wherein the instructions, when executed by the apparatus, further cause the apparatus to:
determine a format for each data layer.

19. The non-transitory computer-readable storage medium of claim 18, wherein the instructions, when executed by the apparatus, further cause the apparatus to:
apply a model to the one or more data layers, wherein the model prohibits duplication of data layer formatting.

20. The non-transitory computer-readable storage medium of claim 15, wherein the instructions, when executed by the apparatus, further cause the apparatus to:
receive a data layer request regarding a specific data layer, wherein the data layer request is associated with a user interaction with the compliance graphic; and
cause, based on the data layer request, display of information about a compliance status of the specific data layer.
